(19) United States
(12) Patent Application Publication
(10) Pub. No.: US 2003/0144886 A1
(43) Pub. Date: Jul. 31, 2003

(54) Method and system for generating textual medical reports

(76) Inventor: Rick K. Taira, Newcastle, WA (US)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 10/060,932

(22) Filed: Jan. 29, 2002

(51) Int. Cl. G06F 17/60

(52) U.S. Cl. 705/3

(57) ABSTRACT

A textual report generation method and system translating structured medical information into textual reports which can be customized in detail and vocabulary for different intended audiences. The structured data may exist in a pre-existing electronic medical record and/or be elicited from patients and medical professionals. Using the structured information, a disease signature is identified which, in turn, identifies the appropriate lexical domain and rules for generating a textual report describing the patient's condition. Context-free grammars are used with a system of rules corresponding to logical relations in the structured data to generate the textual reports.

### TECHNICAL FIELD

The present invention is directed to computer-based medical records. More particularly, the present invention is directed to generating textual reports derived from structured computer data regarding a patient to create medical reports describing the patient's condition in a form relevant to their intended audiences.

### BACKGROUND OF THE INVENTION

Medical research, education, and, most importantly, patient care are increasingly dependent on computer-based information. Computer technology has made it possible both to store enormous quantities of patient information in compact spaces, and to make that information available on demand. Computers' ability to manage this information effectively is hugely important because the body of information not only is overwhelming, but it is growing by the minute. Moreover, our population is growing at an ever-increasing rate, people are living longer than ever before, new data-intensive diagnostic tools have proliferated throughout the medical community, and computer technology makes it more feasible to store vast amounts of information on individual patients.

Clearly, however, being able to store and retrieve this information is only of any benefit if that information is useful to medical professionals. By analogy, one might consider the potential benefits of the Internet. Limitless information exists on the World Wide Web. Further, using any number of search engines, such as Google, Yahoo, and Altavista, a user can find a great deal of information on any topic just by typing a word or phrase that describes the information desired, and the information is returned right to the user's desktop. The problem with the information returned is that, even if every piece of information is entirely relevant to the inquiry, most of the information is not useful because of the way it is presented. The information might be too technical or not technical enough. The information might constitute a table of figures, a fluffy advertising presentation, a paper from a scientific journal, or a superficial reference in an out-dated news article. The user may choose to patiently wade through this glut of information, and eventually he or she may be rewarded with the information wanted in a form that is, at least, workable. In any event, reviewing the retrieved information takes a great deal of time, often the information is confusing, and most of time the information retrieved is not truly relevant.

This is the problem faced by medical professionals, medical administrators, and patients in confronting the wealth of computer-based medical records. Many people need to access patients' records, but they all need different information, and they need it presented differently. Consider the needs of medical professionals: in a realm where patients are many and medical professionals are few, and the cost of healthcare is skyrocketing, the last thing desired is for medical professionals to have to expend literally valuable time pouring over medical records searching for what they need. Nonetheless, medical professionals need to access this information. They need to access this information to evaluate their patients' medical histories to identify, from the patients' collected symptoms, what illnesses might underlie their patients' conditions, and to decide between different courses of treatment.

For example, consider an unfortunate patient who has a cancerous brain tumor, has a history of heart disease, and, not surprisingly, is also suffering from severe depression. The patient will be treated by an oncologist, a cardiologist, and a psychiatrist to be sure, and probably also by radiologists, urologists, and other specialists. The medical professionals treating the patient all need a different collection of information to aid in their respective treatment of the patient. The oncologist treating the cancer needs a long view of that patient's history to understand when the cancer may have originated and how it has metastasized. The oncologist also will require access to computed tomography or other imaging of the cranial region representing the tumor. Moreover, the oncologist will need that imaging information over a period of time to evaluate how the cancer has grown or remitted over time and in response to treatment. Further, review of chemical blood analyses will be important to the oncologist to assess the progress of the cancer and the efficacy of treatment.

The cardiologist also will require a great deal of information, but that information may be entirely different. Surely, the patient's history also will be important to monitor the nature of the patient's cardiovascular system. On the other hand, the types of information the cardiologist needs are very different than that needed by the oncologist. The cardiologist will be interested in the patient's weight and body fat levels, and other statistics monitored over time, none of which may of interest to the oncologist. Similarly, the cardiologist also may need a variety of imaging data, but the cardiologist may or may not need to see the cranial imaging data; instead, the cardiologist needs access to chest X-rays and other thoracic imaging. In addition, while the cardiologist will be interested in blood chemical analysis, the cardiologist will be less interested or uninterested in cell counts and more interested in blood serum cholesterol levels.

Last, but not least, a psychiatrist will be interested in reviewing potential biological sources of the patient's depression. Unlike the other medical professionals, however, the psychiatrist may be interested in past indicia or history of mental illness, which might include information of a domestic nature which will have no import whatsoever to the other medical professionals. The psychiatrist also may be interested in the patient's blood chemical analysis, but undoubtedly will look to different indicators than either the oncologist or the cardiologist; the psychiatrist will want to know if the patient suffers from a brain chemical balance, but may care nothing about cell counts, cholesterol, or other aspects of the patient's blood.

By contrast, of interest to all the medical professionals may be the course of pharmaceutical treatment. Certainly, each of the medical professionals will have to consider what other medications have been or currently are being taken for the other illnesses in order to guard against drug interaction problems. Also, the medical professionals will need to review what other medications the patient has taken to determine if these medications, and not the patient's inherent physiology, are causing certain biological conditions in each specialist's range of interest.

From patients' point of view, they surely may want to review their own medical histories. The law requires that patients' understanding of their choices and consent to treatment must be better informed than ever before. Further, a patient having researched his or her condition—perhaps using the plethora of information available on the Internet—may want to know if certain therapies have been considered, because he or she may be considering switching to different specialists. Similarly, the patient may be considering alternative medicine or homeopathic treatments, and be interested to know how the current course of treatment might relate to those alternative therapies. Ultimately, the patient may want to understand the nature of his or her share of the cost of treatment.

Finally, and not unrelated to any of these persons' concerns, is the multibillion dollar problem of managing and paying for healthcare. Paying for treatment is a paramount concern to individuals, health plan administrators, the government, and the public as a whole. Health plan administrators need to be able to evaluate what courses of treatment have been tried, what might be the best courses of treatment in the future, and how the treatment should be billed.

Against this backdrop, of all these different people needing information of different kinds about a single patient, lies the question about how to get each of these people the information that each needs. Assuming that the information exists on a computer in a structured form, either entered in structured form by using controlled vocabularies or entered in natural language and processed into structured data, that information can be readily accessible; the problem is the selection and presentation of the information. Everyone accessing the patient's information wants to review all the relevant patient information but not be distracted by unwanted information; they need a specific subset of the patient's information. Considering the preceding example, the oncologist needs the information related to the brain tumor, the cardiologist needs the information related to the patient's cardiovascular disease, and the psychiatrist needs a different set of information entirely. There must be a way to help the medical professionals select from among the different categories of information available automatically without requiring the medical professionals to manually wade through the sea of data, to say nothing about the patients, healthcare administrators, and others who want or need to review the patient's history.

Equally important to the selection of information is the way in which the relevant information is presented. Certainly, computer-based information stored in binary form and commonly represented in hexadecimal notation is useless to almost everyone. Yet even translating that information back to the literal way it was entered may not prove helpful. It goes almost without saying that it may be of little utility to the patient to bury him or her with a litany of imaging views, tables of obscurely identified blood work statistics, and even text descriptions if the descriptions are heavily laden with technical terminology. What is not as obvious is the difficulty medical professionals might have in reviewing such information retrieved directly from a patient's electronic medical record (“EMR”).

Studies have shown that medical professionals prefer to review patient information in the manner in which they typically create it: in textual form. Medical professionals commonly dictate their post-examination reports in textual form, leaving to other personnel or other means to transfer that information into structured, computer-understandable information. It is only logical that one who creates reports in textual form also finds it easier to review such reports in textual form. Certainly, anything which makes a medical professional's job easier, certainly if it results in a time savings, would be highly beneficial. Thus, a system that translates tabular, structured, computer-understandable medical information into plain text would be of help medical professionals, and if such a system can also tailor the information to a specific condition and patient it would be much more, useful saving time and money.

One final consideration is the duplication of effort confronted by medical professionals each time he or she creates a patient report. Such reports necessarily begin with the same or similar information, including the patient's name, age, gender, underlying condition, and related information. It is an obvious waste of time for a medical professional to have to regenerate that information in every examination report. It is also essential that most relevant and specific information is recorded. Another benefit of a system that can translate computer-based information into textual is that such a system could automatically produce such information into a textual report, giving the medical professional a head start on generation of such a report thus saving time. A further advantage of such a system is that, in working from computer-based information, the system could be counted upon to not make patient identification or spelling mistakes. The system also could make sure that the basic information is current; for example, from a birth date stored in the patient's EMR, the system could calculate the patient's current age. In addition, the system can present a context for the patient's vital statistics. For example, if the patient is a six-year-old child, the system can communicate what the average heights and weights for a child of that gender would be, and/or present percentile information for ranking that patient. Similarly, the combination of height, weight, and age figures can be used to compare the patient's vital statistics with those of his or her demographic to indicate whether the patient is overweight or underweight. Similarly, the system, if intelligent enough, can give the data and rate of change of the most relevant measurements. For example change in tumor size or blood cholesterol level, etc.

A system which could generate textual patient reports, tailored to the needs of a specific type of reviewer and the patient's relevant condition, could improve the efficiency of medical treatment. In making the work of medical professionals more efficient, the system would help reduce healthcare costs, as well as the administration of such costs. Further, a plain, text medical report of a patient's condition could help that patient's understanding of, appreciation for, and participation in his or her own recovery. Recognition of the benefits of such a system, however, is only part of addressing the needs for such a system. It is not plainly evident how one might go about generating a relevant, tailored and specific and useful textual report from any structured data whether entered or processed by a textual processor.

Generating textual reports from structured data is not an entirely unexplored realm. For example, a simple word processing mail-merge procedure can be regarded as a rudimentary form of generating relevant, useful text from structured data. A mail-merge procedure can generate a number of plain documents that appear to have been created individually for each of the recipients when, in actuality, the resulting documents represent the generation of textual documents from two different bodies of structured data. One of these bodies of structured data is the form or shell document. In the case of mail merge letters, the shell document identifies the placement of the recipient's personal information, includes a generalized message to each of the ultimate recipients, and variables which can be filled in based on information about each of the recipients. The other body of structured data from which the textual documents will be derived is the mailing list. From the mailing list, which is a basic database storing information regarding the recipient's name, address, and sometimes also general details such as age or interests, variables in the form document are filled in to personalize the letter to the recipient.

A mail-merge system is a very basic type of text generation system. Generally, mail-merge systems tend to be highly inflexible, and allow for little variation to account for any variation in the mailing list data or in manipulation of the content of the form letter. Nonetheless, mail-merge is effective: it allows for countless companies to solicit countless potential clients in a specified way, making this solicitation much more useful to both. To take one example, automobile insurance companies can generate solicitation letters that not only are personalized with the recipient's name and address, but can specify rate quote information tailored to the recipient's age, residence, and other information. Clearly, such a tailored letter is much more likely to hold a potential client's interest, because it provides specific information about the recipient's situation, rather than a “dear resident, please call for a personal quote” type of letter.

More sophisticated discourse and dialog generation systems also are in use that improve upon a typical mail-merge system. These systems allow for more flexibility in generation of forms and presentation of other information relevant to the recipient. In the medical realm, various context-specific textual generation systems have been used to generate reports for medical professionals and patients alike. For one example, a text generation system called TraumaGEN was programmed to generate instructions for emergency medical personnel based on structured data provided in a checklist form. For instance, if a patient has suffered a chest trauma, TraumaGEN generates a list of instructions such as “Caution: get chest x-ray immediately to rule out a simple right pneumothorax,” “Caution: get a chest x-ray immediately to rule out a simple right hemothorax,” “Do not perform local visual explorationof all abdominal wounds until after getting a chest x-ray—the outcome of the latter may affect the need to do the former,” and “Please get a chest x-ray before performing local visual exploration of all abdominal wounds because it has a high priority.” In addition, because such staccato instructions can seem contradictory or confusing, TraumaGEN also is programmed to connect logically related phrases such as listed previously to generate a more coherent overall instruction such as “Caution: get a chest x-ray to rule out a simple right pneumothorax and rule out a simple right hemothorax, and use the results of the chest x-ray to decide whether or not to perform local visual exploration of all abdominal wounds.”

Current medical text generation programs are not limited to generating reports for medical professionals. To take another example, an aptly named program called Migraine is programmed to provide educational materials and other information to migraine headache sufferers. A user of the Migraine system is presented with a serious of checklists screens prompting the user to specify the precise nature of his or her condition. Based on this knowledge base developed relative to the user, the system is able to present the user with information about migraines relevant to the user's previously designated condition. Furthermore, the Migraine system can even provide preprogrammed answers to commonly asked questions that might be presented by system users. Users experiencing common symptoms tend to implicate questions commonly asked by persons presenting with that same specific condition.

These are only two representative systems of many that have been offered to the medical profession. Nonetheless, they are representative of the principal common shortcomings of such systems. The reports generated by these systems are generic and limited; TraumaGEN generates generic reports targeted at medical personnel dealing with trauma, while Migraine generates generic information on migraine for patients. Neither of these systems is flexible enough to generate specific and tailored types of reports based on given patient's medical condition. What is needed is a system that can generate reports responsive to the needs of different audience but specific to a given patient's medical condition. For example, bleeding in the right lung in a six-year old boy as a result of a car accident versus bleeding in the right lung in a 50 year old person with cough and cancer. Although they both represent bleeding in the right lung, the type of report, the way in which the information is sought, and the type of information needed are vastly different. It is to these goals that the method and system of the present invention are directed.

### SUMMARY OF THE INVENTION

The present invention is directed at a method and system that describes and establishes a data model and disease signature with the data model correlating disease management with computer input and processing. The model considers patient evaluation in two phases: the initial visit, and subsequent follow-ups. In the initial visit in principle, three items are evaluated for each patient: (a) what is the patient's problem; (b) how serious is the patient's condition; and (c) what should be done for the patient. These three steps are, in turn, mapped to a computer respectively into: (a) data entry; (b) data processing; and (c) data visualization. In subsequent follow-up visits, there are three specific evaluations related to (a) direction; (b) magnitude; and (c) significance.

One application of the present invention thus would be to receive structured medical data based on predefined controlled vocabulary and translate that information into a tailored textual medical report. The first step would be, when the patient presents with a symptom and the diagnosis is not known, as in the case of a new patient, the system then draws from patient input provided directly by the patient and data entered by the nursing and paramedical personnel. The system then records any chief complaint the patient has and further refines the chief complaint with additional questions, and provides information in regard to the review of the patients' other medical condition. Based on this information, the system identifies a disease signature for that patient considering patient evaluation for three steps of (a) what is the patient's problem; (b) how serious is the patient's condition; and (c) what should be done for the patient. If patient is a follow up patient then three elements are evaluated for each patient: (a) direction; (b) magnitude; and (c) significance. In either case having a disease signature facilitates generating a textual report describing the patient and the patient's presented condition addressing the issues related to the to the most relevant findings from each examination. The system thereby, for example, generates a textual report relevant and helpful to the needs of persons reviewing this report, including easy-to-understand reports for the patients, and appropriately detailed reports for healthcare professionals, saving them significant time in documenting patient histories or getting result consults. The system also could generate text framed as database or search engine queries, or as specialized medical and/or billing codes.

### BRIEF DESCRIPTION OF THE DRAWINGS

FIG. 1A is a flowchart beginning from the patient presenting with symptom and the follow up evaluation in a patient with a known diagnosis defining (a) direction; (b) magnitude; and (c) significance.

FIG. 1B is a flowchart of the patient presenting with a symptom in whom there is no previous diagnosis known.

FIG. 2 is a form seeking generic patient related information.

FIG. 3 is a form seeking past relevant medical history and social history in patients.

FIG. 4 is a form seeking the patient's chief complaint and chief complaint qualifier such as symptom duration quality which are specific and dependent on disease signature.

FIG. 5 is a form seeking patient information to be recorded by nursing and physician assistant personnel.

FIG. 6 is form seeking information concerning the medical review of the organ systems for patient to evaluate if there is any other problem with the patient.

FIG. 7A, 7B, and 7C are forms representing examples of training set data for creating the disease signature for a urinary tract disorder.

### DETAILED DESCRIPTION OF THE INVENTION

The present invention is directed at generating textual reports from structured, computer-based data. That data may be previously stored data or data newly entered by a patient, nurses, medical professionals, or other medical professionals. The reports generated will be useful for a variety of users who can review a textual report even though the data was actually created through structured data entry by the reporting individual moments or months before. A medical professional can review a textual report of a patient's symptom before examining the patient, even though the patient may have entered the data in a structured form on a computer screen moments or days before. A medical professional could review a textual report from a referring medical professional, even though the referring medical professional uses structured data entry to create his or her examination reports. Ultimately, the text generated can be reused by a reporting medical professional to create his or her own examination report, saving time in not having to recreate that information. Similarly the same type of textual report generated based on disease signature and structured data input, can be used for documentation required for accurate billing. For example, the relationship between the patient presentation (ICD-9 code) and procedures performed (CPT-4 codes) are accurately and automatically recorded.

Use of a disease signature model creates correspondence between patient evaluation and disease management and computer processing of the resulting data. Patient evaluation and disease management is considered in both the initial phase when the patient first presents for treatment, as well as in subsequent visits. In the initial phase, patient evaluation and disease management comprises three steps:

1. What is the problem? This step requires the following input, primarily based on subjective information obtained from the patient:

a. Patient demographic and age;

b. Patient chief complaint input which in turn is mapped to standard nomenclature (for example if the patient complains of a degree of pain, is objectified from 1 to 5 based on severity);

c. Review of systems given by the patient or obtained by nurse practitioner; and

d. Vital signs including blood pressure, pulse rate, respiratory rate, temperature, height, weight (compared to known charts and relevant to age).

2. How serious is the condition? In this stage, a given potential disease or suspected disease is diagnosed either through physical exam performed by the physician which corresponds to the chief complaint and related to review of systems, or by various measurements as described below:

a. Visualization of anatomy through imaging or endoscopy;

b. Physiologic measurements such as pressure;

c. Electrical activity, such as contractions (e.g., EKG);

d. Histology (e.g., pathology and biopsy);

e. Chemical measurements, including spectroscopy and laboratory tests; and

f. Evaluation of function as measured by functional examinations such as functional MRI or optical imaging.

3. What should be done for the patient? This step relates to the final stage of disease management after diagnosis has been established and generally falls into one of the four categories:

a. Time: The appropriate course of treatment might be to allow time for the disease process to evolve; for example, it might be more appropriate to evaluate pain subsequent to some period of time for rest;

b. Consultation and referrals: It might be appropriate for a physician to refer the patient for a consultation by an appropriate specialist;

c. Surgical treatment: The patient's condition may require surgery by the physician or by an appropriate specialist for the anatomy and specialty at issue; and

d. Medical treatment: The patient's condition may require treatment with medication corresponding to a specific disease entity.

These three major steps in patient evaluation and disease management can be mapped to three phases in which the a data processing environment:

1. Data Entry: This step corresponds with the determination of what is the patient's problem. It generally accepts the data from various inputs, including patients and physicians. Based on machine learning, the system can gradually be enhanced to ask for sophisticated and specific questions.

2. Data Processing: This step corresponds with the determination of the severity of the patient's condition. This step makes use of knowledge bases, making comparisons between the patient's condition and what are considered normal and abnormal conditions recorded in the knowledge bases. In other words, the patient's lab data can be compared to other patients' lab data which proved to be normal; if the patient's data is similar to the lab data, the patient's condition can be regarded as normal, but otherwise can be regarded as abnormal.

3. Data Visualization: This step concerns what should be done for the patient by comparing the nature and the severity of the patient's condition with those of previous patients. Course of treatment provided those previous patients and the outcome of those course of treatment provides useful information in determining what course of treatment might be indicated for this patient. Ideally, the system should provide visualization of the highest density of data in the smallest amount of space. For example, data trends should be depicted in a graphical form as compared to a textual form to help medical professionals more easily assimilate the information represented.

This initial phase of patient treatment is focused on establishing the existence and extent (“EE”) of disease. Subsequent, follow-up visits are directed to determining three aspects of the patient's condition:

1. Direction: The direction of a potential disease or lesion detected previously is, simply, whether the patient's condition is improving or worsening. For example, if a tumor was detected initially, the size of the tumor may increase, decrease, or remain the same; if the patient presented with pain in a given part of the body, the extent of the pain might be lessening, worsening, or remain the same.

2. Magnitude: Magnitude can be quantified in terms of actual or subjective measurements. Actual measurements record physical parameters of a lesion, such as mass, physical dimensions, etc. Subjective measurements represent assessments of an observer of what he or she considers the magnitude of the disease process to be. For example, a mass or lesion might be regarded as “huge,” “large,” “small,” etc., while pain might be rated on a scale “from 1 to 5.” Such subjective measurements might be provided by the physician or by the patient.

3. Significance: The significance of the disease to the computer system will be gradually established based on machine learning. In other words, the computer can compare and contrast the data with a corpus of previously entered reports and the physicians' assessments of those reports. Accordingly, upon recognizing similar data patterns from previous cases, the system can retrieve and report how the physicians in those prior cases described the situation and/or what they concluded, as well as the end result of what was the patient outcome.

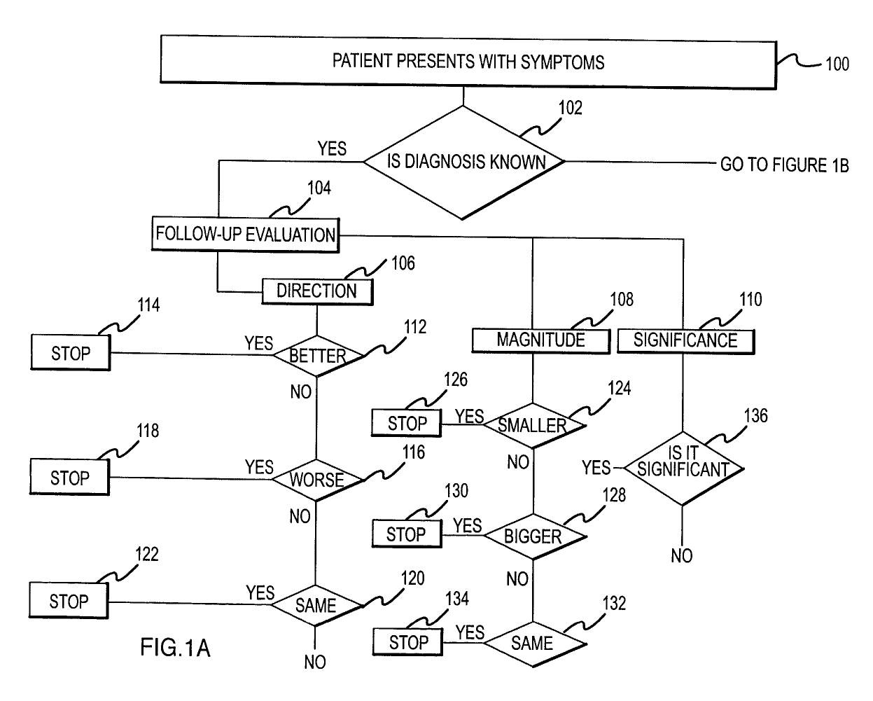

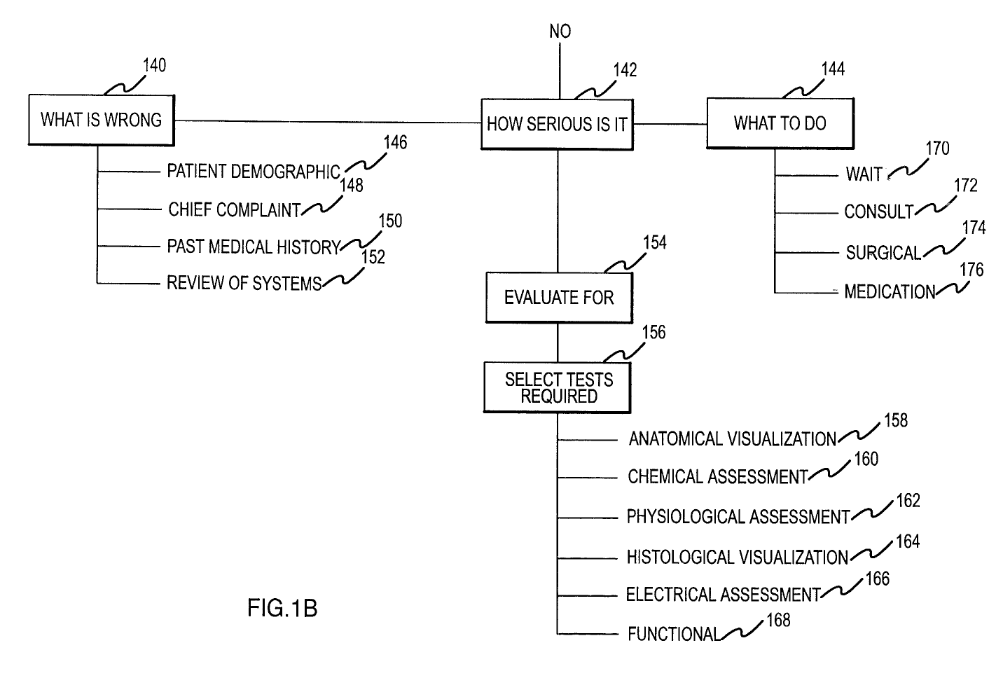

FIGS. 1A and 1B overview the data model and the overall process used by an embodiment of the present invention. As shown in FIG. 1A, the patient presents at 100. At 102 it is determined whether the patient's diagnosis is known. If the patient's diagnosis is known, either because the patient is a returning patient or the details of the patient's condition have otherwise been provided, the patient is assessed according to protocols for a follow-up evaluation at 104.

As previously described, in such a patient three specific items are assessed: direction 106, magnitude 108, and significance 110. Direction 106 is assessed by determining whether a known disease entity, such as a tumor or a localized pain, is getting better 112. If it is better 112, the direction assessment stops at 114. If the disease entity is not better 112, and if the assessment is that the disease entity is worse 116, the direction assessment stops at 118. If the disease entity is neither better 112 nor worse 116, then the disease entity has remained the same 120, and the direction assessment stops at 122.

The magnitude 108 of the medical problem is assessed by actual measurement and/or by subjective description by the physician or the patient. If it is smaller 124, the magnitude assessment stops at 126. If the disease entity is not smaller 124, and if the assessment is that the disease entity is bigger 128, the magnitude assessment stops at 130. If the disease entity is neither smaller 124 nor bigger 128, then the disease entity has remained the same 132, and the direction assessment stops at 134.

Significance 110 is based on an objective assessment by an expert and subsequent machine learning. For example, if a tumor is getting smaller but other tumors are developing the fact that original tumor size is getting smaller is not a significant improvement and would be recorded as such.

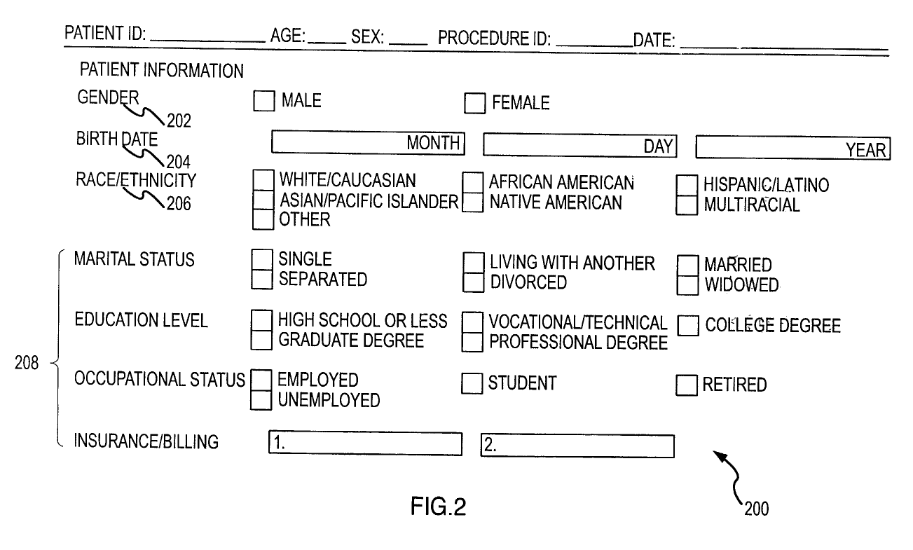

FIG. 1B is a flowchart of the assessment of a patient whose diagnosis is not yet known. Here, three considerations are utilized in the overall assessment of the patient: what is the problem or what is wrong with the patient 140; how serious is the patient's problem 142; and what should be done or what treatment is indicated for the patient 144. What is wrong is further evaluated by recording patient demographics 146, chief complaints 148, past medical history 150, and review of the system 152 to be subsequently described with regard to FIGS. 2 through 6 to determine if there is a preexisting body of knowledge regarding this patient.

How serious is the problem 142 is generally assessed utilizing one of the six categories:

(A) Anatomical visualization 158, generally performed using imaging or endoscopy 158;

(B) Chemical assessment 160, generally performed using chemical and laboratory tests;

(C) Physiological assessment 162, generally refers to physical measurements;

(D) Histological visualization 164, generally referring to refers to pathological microscopy examinations;

(E) Electrical assessment 166, generally referring to measuring electrical conduction by electrocardiogram or electrical activity of the brain as measured by the electroencephalogram; and

(F) Function 168, generally referring to measuring by functional MRI and optical imaging.

Finally, what to do to treat the patient 144 could comprise a number of courses of treatment, but generally can be categorized into four groups:

(A) Wait 170 to see if the condition heals itself;

(B) Consult 172 if a second opinion or a specialist is needed;

(C) Surgical treatment 174 as needed; and

(D) Medication 176 as needed.

As described in FIG. 1B, if background information on the patient is not already available in the system, it will have to be collected and entered into the system. This information can be entered in a number of known ways, such as by keyboard, graphical interface, speech recognition, and other means. It should be noted that these illustrative forms and the example that follows concern a suspected urinary tract problem and evaluation. Certainly, the embodiment of the present invention can be tailored to seek information relevant only to the suspected problem of the patient, or the specific specialty the examining/treating physician practices.

As indicated in FIG. 1B, patient demographic data 200 must be gathered of the type listed in FIG. 2. The system must be apprised of the patient's gender 202, birth date/age 204, race 206, and other factors 208. Such information can be highly relevant to diagnosis and treatment. Just to list a few examples, diseases related to males and females or different ethnicities vary. Accordingly, this data should be available to assist the system in generating useful, meaningful reports.

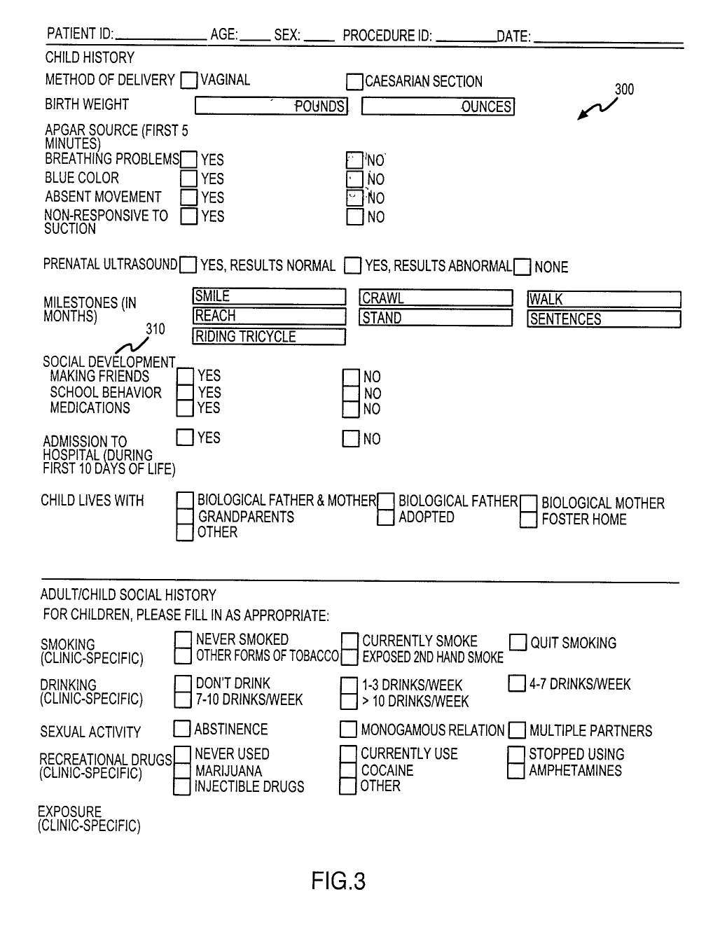

FIG. 3 is a form for gathering past medical history 300. Certainly past medical history 300, including social development 310, is highly relevant to diagnosis and treatment. Past medical history 300 also is highly relevant to determining what might be the patient's disease and what treatment might be indicated.

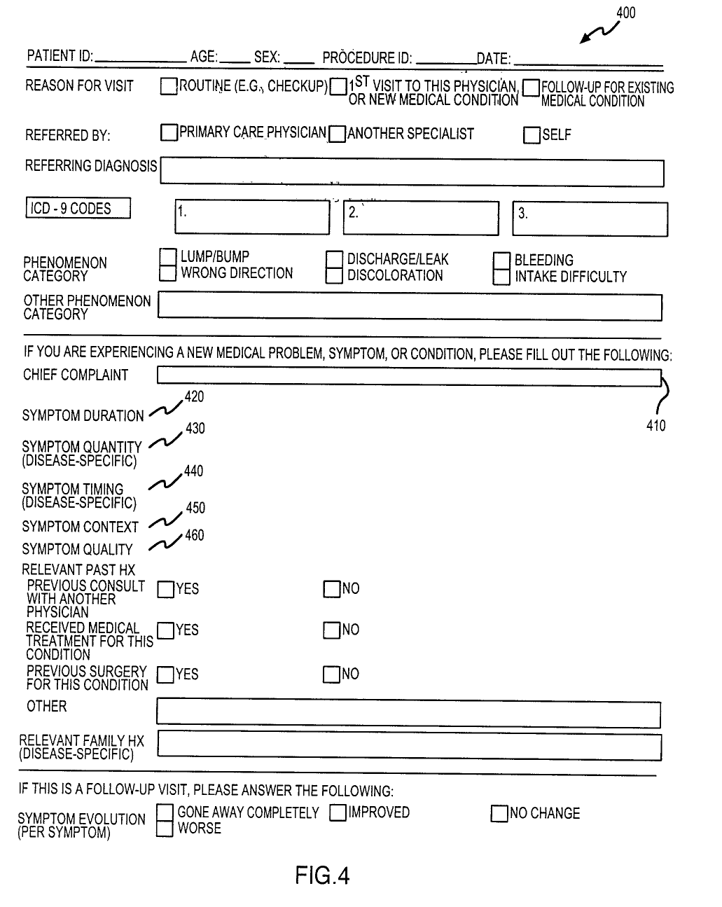

FIG. 4 is a form for gathering information concerning the reason for the patient's medical visit 400. Among other information, the form seeks the patient's chief complaint 410 and seeks information to further refine the chief complaint 410 with qualifying questions related to the duration of the symptoms 420, the quantity of the symptoms 430, the timing of the symptoms 440, the context of the symptoms 450, and the quality of the symptoms 460. The nature of the symptom and these quantifiers are significant indicators of a patient's disease entity. For example, assume the patient presents with a painful flank. Further, assume that the pain is short in duration and colicky in nature, and also associated with blood in the urine. The quantifiers of the symptoms suggest that the patient's disease entity most likely relates to a stone in the urinary tract. On the other hand, a patient who presents with flank pain and fever most likely presents with a disease entity relating to an inflammatory process involving the kidney.

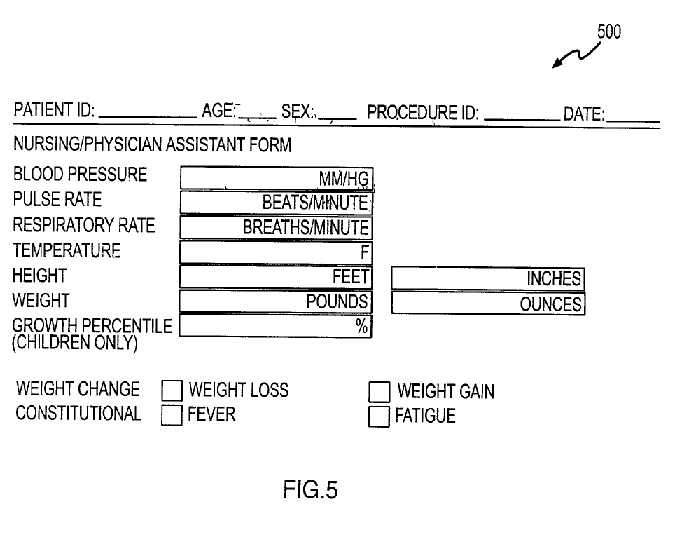

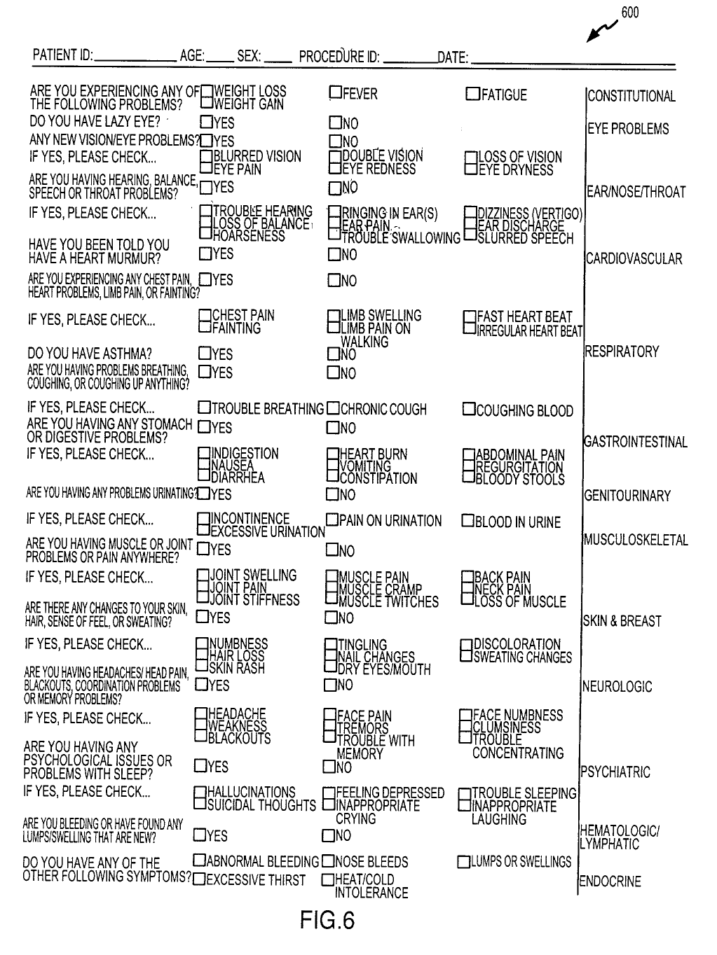

Other information also is required to ensure a complete set of patient information exists which could modify diagnosis or treatment. Anything from the patient's blood pressure to reported sleeplessness might further implicate the nature of the disease entity, or could limit or suggest different forms of treatment. FIG. 5 is a form filled by the nursing staff to record objectively all vital signs 500. FIG. 6 is a review of symptoms reported by the patient, the information perhaps being obtained through questioning by or with assistance from a paramedical professional, to complete the patient's medical situation.

Gathering information on the patient being examined provides a source for detailed observations about that specific patient in creating reports about that patient. Also used in the present invention is a knowledge base containing information about patients presenting with problems like that of the instant patient. This knowledge base is used to identify the disease signature which is indicated by the patient's problem and, thus, to generate relevant reports concerning the patient's situation.

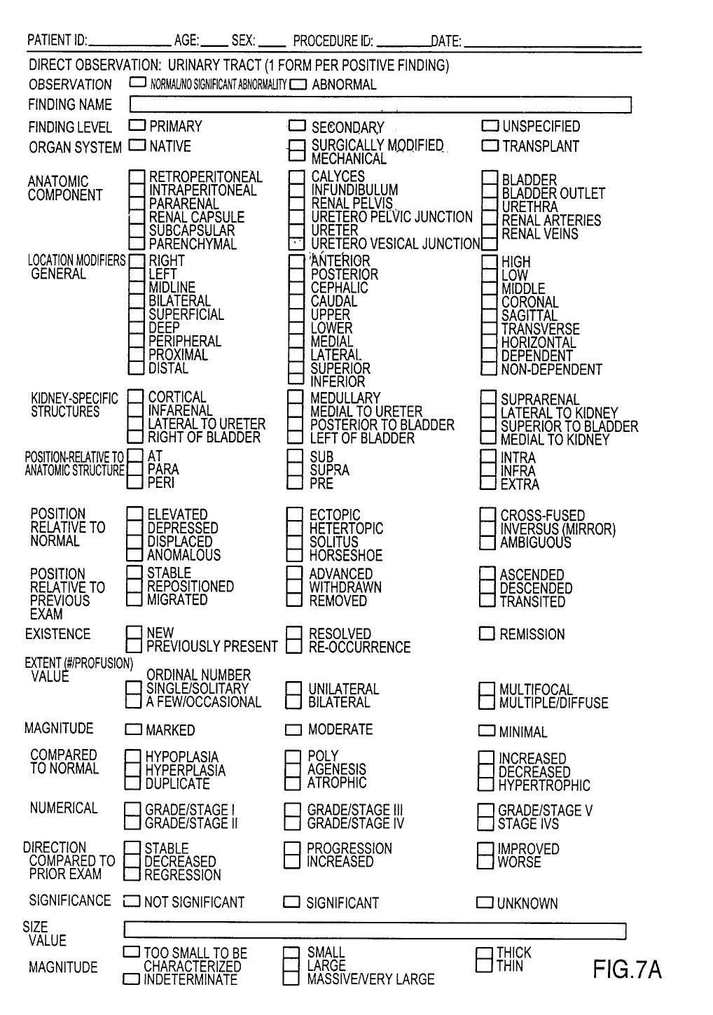

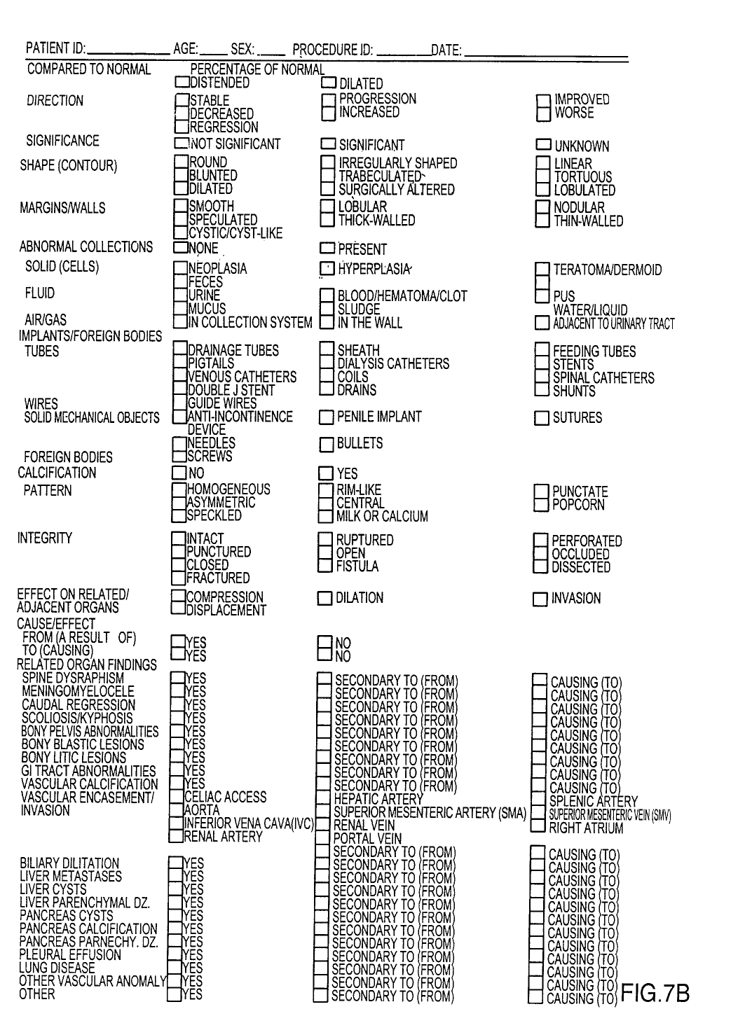

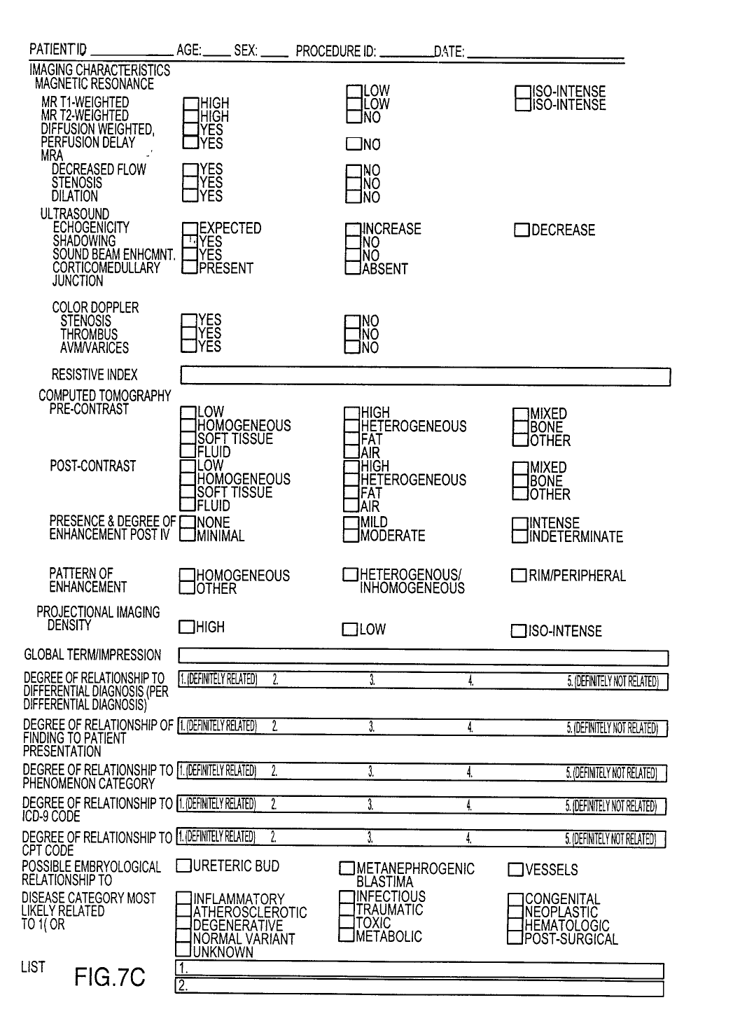

FIG. 7A, 7B and 7C are forms to be used to gather data to create the system's disease signature. As previously mentioned, the figures included in this description relate to urinary tract problems. Specifically, these forms are used in recording results of obtained through direct observation, which might include direct imaging, endoscopy, or surgical laparoscopy. It could also include measurements of electrical activities, physiological activities or chemical measurements related to urinary tract whether blood or urine.

Collecting data through these detailed forms structures the existing medical data in a given field, such as in the present example of a urinary tract disorder, to develop the appropriate training set for computers to understand the disease signature. Lexicons are developed for each disease signature or disease signature category. Words and word phrases to be included in the lexicon are gathered from two distinct sources. The first source relates to information collected from public sources including the indices of medical textbooks, review manuals and other published medical glossaries. For example, in thoracic radiology, glossaries compiled by nomenclature committees of Fleischner Society are consulted. Incorporating designations used in these published sources ensures that the lexicon entries for each word or phrase properly reflects the range of generality for which the word or phase might be used. From these sources, an index of terms is compiled. Each of these terms is looked up in the lexicon to determine if that term is already entered in the lexicon.

Obviously, all potential different sequences of words or string representation that might be used in medicine are not available in any published material. Therefore a second source of terms to include in the lexicon are from the actual medical reports from a specific domain, such as in a genitourinary tract. The collection of words and word phases from actual reports ensures that the system works at a practical level, and that string representation for at least most of the basic concepts prevalent to that domain are included.

One aspect of a preferred embodiment of this invention would gather, for each domain of each category of disease, ten-thousand or more medical reports analyzed as part of generating a disease signature consistent with FIGS. 7A, 7B and 7C. Recognizing a large number of semantic classes allows the output of the preferred embodiment of the invention to accurately model the expression of every specific condition. When a training set is completed, then the computer has sufficient information to recognize a disease signature based on the patient's input. In other words, once the structured data indicates the nature of the problem, together with its direction, magnitude, and other factors, combined with the other information collected about the patient, the system has a body of data completely describing the condition. The lexicon collected from medical sources, combined with the numerous medical reports digested in accordance with FIGS. 7A, 7B, and 7C, then allows for the correlation of appropriate text to describe that data.

An example further defines the operations of an embodiment of the present invention by showing how a textual medical report maps to structured data. Essentially, this example shows the reverse-engineering of a textual report to structured data made up of variables and values to show how an embodiment of the present invention will take those same variable and values in the structured data and generate a textual report.

Assume the following report exists for a given patient:

Patient Smith is a 7-year-old female with history of urinary incontinence. She has been seen by a urologist which finds no other abnormality except the patients complaint. Incontinence has been in existence since birth and occurs during day and night. The patient has recently had an ultrasound and CT urogram examination which shows the following findings:

Right kidney function promptly with no abnormalities.

On the left side the kidney appears small and deformed. It also functions slower than the right. The right ureter is visualized and appears normal. The left ureter is partially seen and appears to insert ectopically into the vagina.

Conclusion: Hypoplastic left kidney with ectopic ureter. Each of these phrases in the medical report can be parsed into their component structures. The phrases correlate with a particular aspect or variable describing the patient, and the words used pertain to those variables as indicated:

1. This is a 7 year old female with history of urinary incontinence.

Patient Age (This, 7 yo)

Patient—Sex (This, female)

Patient—History (This, history of, incontinence)

Finding—Body Sub (Incontinence, urinary)

2. The right kidney functions promptly with no abnormalities.

Anat—normality (kidney, function, promptly)

Anat—normality (kidney, EQ, abnormalities)

Negation (abnormality, =, no)

Anat. Dir (kidney, right)

3. On the left side, the kidney appears small and deformed.

Physiology—size (kidney, appears, small)

Amt—dir (kidney, left side)

Anat—perturbation (kidney, =, deformed)

4. It also functions slower than right.

Physobj—normality (Lt, functions, slower)

State—Inontinence-physobj (slower, than, right)

5. Right ureter is visualized and appears normal.

Physiobj—existence (Ureter, is, visualized)

Physobj—normality (Ureter, appears, normal)

Amt—Direc (ureter, right)

6. Left ureter is partly seen and appears to insert ectopically into the vagina.

Physobj—existence (ureter, is, seen)

Physobj—dir (ureter, left)

Percentage (seen, partly)

Physobj—location (Ureter, insert, vagina)

Verb—SpatMod (insert, ectopically).

7. Hypoplastic left kidney with ectopic ureter.

Findings—location (hypoplastic, kidney)

Physobj—Dir (kidney, left)

Finding—Location (ureter, ectopic)

Finding—finding ({hypoplastic L kidney} with, {Ect. US}

Since the patient data can be completely structured, it now can be mapped to a given table. Based on that map, a disease signature can be defined. By analogy, A disease signature is very similar to genetic mapping in a human, except it is based on disease. The following table further clarifies this process:

| | | | | | | |
|---|---|---|---|---|---|---|
| Ab- | | Devi- | | Dupli- | Hypo- | |
| sent | Ectopic | ated | Dilated | cated | plastic | Normal |

| | | | |
|---|---|---|---|
| R Kidney | | | x |
| Lt Kidney | | x | |
| R ureter | | | x |
| L ureter | x | | |
| R pelvis | | | x |
| L pelvis | | x | |
| Urethra | | | |
| Bladder | | | |

By looking at this table it is clear that this patient has normal right kidney and normal right ureter, but on the left side, the kidney is hypoplastic, ureter is ectopic and left renal pelvis also is hypoplastic.

By knowing this disease signature, then it is possible to generate a textual report similar to the one originally examined. Based on the knowledge base built from medical sources previously described, identification of a particular disease signature implicates a particular lexicon and set of construction rules for its description.

In creating the report, text is generated to encapsulate the structured data in a readable, textual form. The system uses context free grammars in which there exists a one-to-one correspondence between a set of logical relations and a construction rule. When describing the state of a finding, the system first locates within the knowledge base all relevant logical relation properties associated with the finding. For example, with regard to the study of an abnormal body mass, the logical relations existence, size, external architecture, location, and calcification pattern would be used by the medical professional to describe the finding of the “mass.” For each logical relation, the knowledge base includes a set of grammatical construction rules to express the relation in English. For example, the system might recognize a logical relation “hasSize” to specify that the “mass” as focus of the logical relation requires a definite article (i.e., “the”), that the predicate of the relation is expressed using an appropriate verb (i.e., “measures”), and that the value of the relation expressed in units of either centimeters or millimeters. The logical relations can be combined into more complex relations by applying formation rules. For example, the “hasSize” logical relation can be combined with the logical relation “hasPrecision” to indicate the precision of the size measurement, such as whether the medical professional entered his finding of the size of the mass as being “exactly” the size specified or “approximately” that size. The formation rules for combining logical relations define the types of syntactic structures to be created and the relative phrasing order.

As previously described, the nature of the report will be modified to suit the intended audience. A healthcare plan administrator, for example, may not be expected to have any interest in the “mass,” beyond its existence and the nature of the course treatment. Accordingly, the logical relations “hasSize,” “hasPrecision,” and others may be omitted from the report for that reviewer. By contrast, these relations might be highly important to a medical professional to whom the case is being referred, and such findings surely would be included in the report generated for that reviewer. Also, if the patient desires a report, all the findings might be included, but the system might draw from a different vocabulary in creating the text to describe the logical relationships. For example, the mass might be redesignated as a “growth,” and instead of the mass being described as situated in “an upper right lobe of the lung,” the mass may be described as located “on the right side of the lung toward the top.” Specifying the audience for the report will dictate what logical relations need to be included in the report, and what rules and vocabularies are used to generate the specific text included in the report as well.

It will be appreciated that lexicons and construction rules can be used to generate reports not only for human audiences with different levels of expertise, but also for other audiences. For example, the audience may not be a human reader, but a database search engine. Accordingly, construction rules could be designed to generate database queries in a Boolean form or in any other type of database query format in order to seek information on similar cases. Instead of the system applying rules of construction to create grammatical sentences, the system would apply rules to insert the correct operators to generate the appropriate query. Even if such a query is submitted to a generalized internet search engine, because the disease signature implicates medically precise terminology for the disease entity, there is a high probability that cogent and relevant information may be retrieved. For another example, the lexicon and rules of construction could be defined to generate specific descriptive codes to be used for billing purposes or otherwise specifically categorize the report for medical and statistical study.

It is to be understood that, even though various embodiments and advantages of the present invention have been set forth in the foregoing description, the above disclosure is illustrative only. Changes may be made in detail, and yet remain within the broad principles of the invention.

1. A method for generating a textual report from structured computer-based data comprising:
collecting a body of information about a patient presenting with a disease entity, collecting the body of information using at least one of a preexisting body of data on a patient, input elicited from the patient, and input elicited from at least one medical professional;
identifying a disease signature for the disease entity corresponding to the body of information collected about the patient; and
using the disease signature to identify a lexical domain containing logical relations and vocabulary relevant to the disease signature and a plurality of findings made by at least one medical professional, the lexical domain following a set of rules to determine how the plurality of findings should be selected, interdepend and be textualized to generate the textual report to describe the findings.

2. The method of claim 1 wherein the input elicited from the patient is collected by requesting answers to a list of structured questions presented to the patient.

3. The method of claim 1 wherein the input is elicited from the patient by a computing system.

4. The method of claim 1 wherein the input is elicited from the patient with a printed questionnaire.

5. The method of claim 1 wherein the input is elicited verbally from the patient by an agent of the medical professional.

6. The method of claim 1 wherein the input is elicited from the patient in advance of a visit to the medical professional.

7. The method of claim 1 wherein the input is elicited from the patient during a visit to the medical professional.

8. The method of claim 1 wherein the input elicited from the patient is relevant to at least one of a complaint given by the patient, a specialization of the medical professional from whom the patient seeks treatment, and a reason for referral specified by a referring medical professional.

9. The method of claim 1 wherein the plurality of findings is textualized using context free grammars.

10. The method of claim 1 wherein the rules for textualizing the plurality of findings observes a one-to-one correspondence between a set of logical relations and a construction rule.

11. The method of claim 1 wherein the set of rules for textualizing the plurality of findings is adapted to an intended audience.

12. The method of claim 1 wherein the vocabulary used for textualizing the plurality of findings is adapted to an intended audience.

13. A method for generating a textual report from structured computer-based data on a body of information about a patient using at least one of a preexisting body of data on a patient, input elicited from the patient, and input elicited from a plurality of medical professionals comprising:
identifying a disease signature corresponding to the body of information collected about the patient; and
using the disease signature to identify a lexical domain containing logical relations and vocabulary relevant to the disease signature and a plurality of findings made by the plurality of medical professionals, the lexical domain following a set of rules to determine how the plurality of findings should be selected, interdepend and be textualized to generate the textual report to describe the findings.

14. The method of claim 13 wherein the input elicited from the patient is collected by requesting answers to a list of structured questions presented to the patient.

15. The method of claim 13 wherein the input is elicited from the patient by a computing system.

16. The method of claim 13 wherein the input is elicited from the patient with a printed questionnaire.

17. The method of claim 13 wherein the input is elicited verbally from the patient by an agent of the medical professionals.

18. The method of claim 13 wherein the input is elicited from the patient in advance of a visit to the medical professionals.

19. The method of claim 13 wherein the input is elicited from the patient during a visit to the medical professionals.

20. The method of claim 13 wherein the input elicited from the patient is relevant to at least one of a complaint given by the patient, a specialization of medical professionals from whom the patient seeks treatment, and a reason for referral specified by a referring medical professional.

21. The method of claim 13 wherein the plurality of findings is textualized using context free grammars.

22. The method of claim 13 wherein the rules for textualizing the plurality of findings observes a one-to-one correspondence between a set of logical relations and a construction rule.

23. The method of claim 13 wherein the set of rules for textualizing the plurality of findings is adapted to an intended audience.

24. The method of claim 13 wherein the vocabulary used for textualizing the plurality of findings is adapted to an intended audience.

25. A system for generating a textual report from structured computer-based data comprising:
a body of data on a patient including at least one of input elicited from the patient, and input elicited from a plurality of medical professionals;
a disease signature identifier to identify a disease signature corresponding to the medical condition and symptoms of the patient; and
a text generator that uses the disease signature to identify a lexical domain containing logical relations and vocabulary relevant to the disease signature and a plurality of findings made by the plurality of medical professionals, the lexical domain following a set of rules to determine how the plurality of findings should be selected, interdepend and be textualized to generate a textual report to describe the findings.

26. The system of claim 25 wherein the input elicited from the patient is collected by requesting answers to a list of structured questions presented to the patient.

27. The system of claim 25 wherein the input is elicited from the patient by a computing system.

28. The system of claim 25 wherein the input is elicited from the patient with a printed questionnaire.

30. The system of claim 25 wherein the input is elicited verbally from the patient by an agent of the medical professionals.

31. The system of claim 25 wherein the input is elicited from the patient in advance of a visit to the medical professionals.

32. The system of claim 25 wherein the input is elicited from the patient during a visit to the medical professionals.

33. The system of claim 25 wherein the input elicited from the patient is relevant to at least one of a complaint given by the patient, a specialization of medical professionals from whom the patient seeks treatment, and a reason for referral specified by a referring medical professional.

34. The system of claim 25 wherein the plurality of findings is textualized using context free grammars.

35. The system of claim 25 wherein the rules for textualizing the plurality of findings observes a one-to-one correspondence between a set of logical relations and a construction rule.

36. The system of claim 25 wherein the set of rules for textualizing the plurality of findings is adapted to an intended audience.

37. The system of claim 25 wherein the vocabulary used for textualizing the plurality of findings is adapted to an intended audience.

38. A system for generating a textual report from structured computer-based data on a body of information about a patient using at least one of a preexisting body of data on a patient, input elicited from the patient, and input elicited from a plurality of medical professionals comprising:
a body of data on a patient including at least one of input elicited from the patient, and input elicited from a plurality of medical professionals;
a disease signature identifier to identify a disease signature corresponding to the medical condition and symptoms of the patient; and
a text generator that uses the disease signature to identify a lexical domain containing logical relations and vocabulary relevant to the disease signature and a plurality of findings made by the plurality of medical professionals, the lexical domain following a set of rules to determine how the plurality of findings should be selected, interdepend and be textualized to generate the textual report to describe the findings.

39. The system of claim 38 wherein the input elicited from the patient is collected by requesting answers to a list of structured questions presented to the patient.

40. The system of claim 38 wherein the input is elicited from the patient by a computing system.

41. The system of claim 38 wherein the input is elicited from the patient with a printed questionnaire.

42. The system of claim 38 wherein the input is elicited verbally from the patient by an agent of the medical professionals.

43. The system of claim 38 wherein the input is elicited from the patient in advance of a visit to the medical professionals.

44. The system of claim 38 wherein the input is elicited from the patient during a visit to the medical professionals.

45. The system of claim 38 wherein the input elicited from the patient is relevant to at least one of a complaint given by the patient, a specialization of medical professionals from whom the patient seeks treatment, and a reason for referral specified by a referring medical professional.

46. The system of claim 38 wherein the plurality of findings is textualized using context free grammars.

47. The system of claim 38 wherein the rules for textualizing the plurality of findings observes a one-to-one correspondence between a set of logical relations and a construction rule.

48. The system of claim 38 wherein the set of rules for textualizing the plurality of findings is adapted to an intended audience.

49. The system of claim 38 wherein the vocabulary used for textualizing the plurality of findings is adapted to an intended audience.
